(19) United States
(12) Patent Application Publication
(10) Pub. No.: US 2012/0273285 A1
(43) Pub. Date: Nov. 1, 2012

(54) METHOD OF CONVERTING, STORING AND UTILIZING POTENTIAL ENERGY AT A WORKSITE AND SYSTEM USING THE SAME

(75) Inventors: Jeffrey E. Jensen, Dunlap, IL (US); Larry M. Slone, Peoria, IL (US)

(73) Assignee: Caterpillar Inc., Peoria, IL (US)

(21) Appl. No.: 13/094,909

(22) Filed: Apr. 27, 2011

(51) Int. Cl. B60K 1/04; H02P 3/14

(52) U.S. Cl. 180/65.1; 318/376

(57) ABSTRACT

A method of utilizing potential energy at a worksite comprising providing an energy storage machine including an energy storage system at a first rendezvous height above a working area, coupling the energy storage machine to a first work machine, generating energy while commuting the energy storage machine and first work machine down the first height, storing the generated energy in the energy storage system and decoupling the energy storage machine and the first work machine at a second rendezvous point adjacent to the working area.

### TECHNICAL FIELD

The present disclosure relates generally to machines that include an electric motor, and more particularly to an off-highway electric-drive machine and battery trailer system and method of using the same.

### BACKGROUND

Various machines utilize an electric motor to provide motive-force to propel the machine. Depending upon the application and configuration, the electric motor may be the primary supplier of motive-force, such as in a purely electric machine, or may act as a supplemental supplier of motive-force, as in certain types of hybrid-electric machines. The electric motor requires energy provided by a power source in order to generate the motive-force to propel the machine. The power source may vary from application to application, examples of which include: a battery-only power source in which the electric motor draws power only from a battery; an engine and generator combination in which a generator transforms mechanical energy from an engine into electrical energy to be used by the electric motor; and various combinations thereof.

United States Patent Publication No. 2010/0147604 discloses a plug-in electric automobile having a trunk section modified to accept an auxiliary battery disposed on a separable assembly. U.S. Pat. No. 5,559,420 discloses an electric supply unit trailer that carries auxiliary batteries and may be towed behind an electric machine for supplying power to the electric machine during driving operations. U.S. Pat. No. 6,973,880 discloses an off-highway machine utilizing fraction motors and generating and storing power from regenerative braking in batteries located on/within the off-highway machine. However, all of the above mentioned applications have drawbacks regarding the weight and complexity of the associated batteries. The present disclosure seeks to cure such deficiencies.

### SUMMARY

In one aspect, a method for utilizing potential energy at a worksite includes; providing an energy storage machine including an energy storage system at a first rendezvous point at a first height above a working area, coupling the energy storage machine to a first work machine, generating energy while commuting the energy storage machine and first work machine down the first height, storing the generated energy in the energy storage system, and decoupling the energy storage machine and the first work machine at a second rendezvous point adjacent to the working area.

In another aspect, an energy conversion, storage and utilization system includes; a worksite including a first rendezvous point and a second rendezvous point disposed at a first height below the first rendezvous point, at least one energy storage machine which includes a regenerative braking system that generates energy while commuting the energy storage machine from the first area to the second area down the first height, and an energy storage system that stores the generated energy, and at least one work machine which is coupled to at least one of the at least one energy storage machines, wherein the at least one energy storage machine and the at least one work machine are coupled at the first rendezvous point and decoupled at the second rendezvous point.

In another aspect, an energy storage machine includes; a chassis, a motive assembly connected to the chassis, an energy storage system and a coupler configured for connection with a work machine, wherein the coupler mechanically couples the energy storage machine to the work machine and the coupler provides an energy transfer path between the work machine and the energy storage system.

Other features and aspects of this disclosure will be apparent from the following description and the accompanying drawings.

### BRIEF DESCRIPTION OF THE DRAWINGS

FIG. 1 is a schematic diagram of an exemplary embodiment of a work machine;

FIG. 2 is a schematic diagram of an exemplary embodiment of an energy storage machine;

FIG. 3 is a schematic diagram of a configuration wherein the work machine of FIG. 1 and the energy storage machine of FIG. 2 are coupled;

FIG. 4 is a schematic diagram of an exemplary embodiment of a worksite;

FIG. 5 is a schematic diagram of a first step in an exemplary embodiment of a method of utilizing the energy storage machine to store energy;

FIG. 6 is a schematic diagram of a second step in an exemplary embodiment of a method of utilizing the energy storage machine to store energy;

FIG. 7 is a schematic diagram of a third step in an exemplary embodiment of a method of utilizing the energy storage machine to store energy;

FIG. 8 is a schematic diagram of a fourth step in an exemplary embodiment of a method of utilizing the energy storage machine to store energy;

FIG. 9 is a schematic diagram of a fifth step in an exemplary embodiment of a method of utilizing the energy storage machine to store energy;

FIG. 10 is a schematic diagram of a first step in an exemplary embodiment of a method of utilizing the energy storage machine to expend energy;

FIG. 11 is a schematic diagram of a second step in an exemplary embodiment of a method of utilizing the energy storage machine to expend energy;

FIG. 12 is a schematic diagram of a third step in an exemplary embodiment of a method of utilizing the energy storage machine to expend energy;

FIG. 13 is a schematic diagram of a fourth step in an exemplary embodiment of a method of utilizing the energy storage machine to expend energy; and

FIG. 14 is a schematic diagram of a fifth step in an exemplary embodiment of a method of utilizing the energy storage machine to expend energy.

### DETAILED DESCRIPTION

The present disclosure is directed towards a system and method for utilizing otherwise unused potential energy in a manner that maximizes a machine to battery weight ratio and a machine to battery unit ratio. Specifically, the method provides utilizing a relatively small number of energy storage machines, as compared to work machines, strategically positioned at energy generation and energy expenditure areas within a worksite. The energy storage machines may be coupled to work machines to capture energy generated by the work machines at energy generation sites and may be coupled to work machines to expend energy at energy expenditure areas. The energy storage machines may be de-coupled from the work machines when the work machines reach areas within the worksite where excess energy expenditure/generation does not occur.

FIG. 1 illustrates an exemplary embodiment of a work machine 100, one exemplary embodiment of which may be an off-highway truck. In another exemplary embodiment, the work machine 100 may be configured for an underground mine site environment. In the present embodiment, the work machine 100 includes a chassis 110 and a dump body 120 connected to the chassis 110. In one exemplary embodiment, the dump body 120 may be movably connected to the chassis 110 via a hinge (not shown) or other assembly in order to allow the dump body 120 to be angled such that the contents thereof may be deposited outside of the work machine 100. Alternative exemplary embodiments include configurations wherein the dump body 120 includes alternative means for emptying the contents thereof, e.g., a controllable opening disposed in a bottom of the dump body 120 and extending through the chassis 110 such that the contents of the dump body 120 may be dropped directly underneath the work machine 100. Alternative embodiments also include configurations wherein the dump body 120 is omitted.

In the present exemplary embodiment, the work machine 100 also includes a set of wheels 130 that are rotatably connected to the chassis 110. Alternative exemplary embodiments include configurations where the wheels 130 may be modified or replaced with a tracked assembly (not shown) or various other similar devices.

In order to provide motive force to the wheels 130, the work machine 100 includes a propulsion system 140. In the present exemplary embodiment, the propulsion system 140 includes an internal combustion engine (“ICE”) 142 that converts chemical energy into mechanical energy via combustion of a fuel, e.g., diesel fuel. In the illustrated embodiment, the mechanical energy produced by the ICE 142 is converted to electrical energy via a generator 144. The generator 144 is not particularly limited and may be any of several well-known mechanical-to-electrical energy conversion devices, e.g., an alternator. Electrical energy produced by the generator 144 is then passed via wiring 146 to at least one electric traction motor 148 that provides motive power to at least one of the wheels 130. In the illustrated embodiment, the work machine 100 includes an electric traction motor 148 on each of the wheels 130 in an all-wheel drive configuration. The at least one electric traction motor 148 is configured to provide a regenerative braking ability as will be discussed in more detail below.

Although one embodiment of providing motive force to the wheels 130 has been discussed above with respect to an all-electric drive configuration, the present disclosure is not limited thereto. The disclosure may equally relate to a hybrid drive configuration wherein a mechanical linkage (not shown) located between the ICE 142 and the wheels 130 also provides motive force in addition to the electric traction motor 148 among various other configurations.

In addition to the above components, the propulsion system 140 also includes a first connection assembly 150 for electrical connection to an energy storage machine 200. In one exemplary embodiment, the energy storage machine 200 may be a battery trailer. In one exemplary embodiment, the first connection assembly 150 provides both an electrical connection and a mechanical connection to the energy storage machine 200. Although the present disclosure is not limited thereto, the first connection assembly 150 may include any one of a mechanical Janney-type coupler (not shown), a tow hitch, an induction-type coupler, a magnetic-type coupler, a power take off (“PTO”) unit and yoke (not shown), and a pintle hook and lunette ring and a separate electrical connection (not shown). In another exemplary embodiment, the mechanism that provides the mechanical coupling may also provide the electrical coupling. The first connection assembly 150 is electrically connected to the at least one electric traction motor 148. Exemplary embodiments include configurations wherein the first connection assembly 150 is directly electrically connected to the at least one electric traction motor 148 and configurations wherein the first connection assembly 150 is electrically connected to the at least one electric fraction motor 148 via various electrical signal regulating apparatus, e.g., a transformer (not shown), a voltage regulator (not shown), a voltage inverter/converter (not shown), etc.

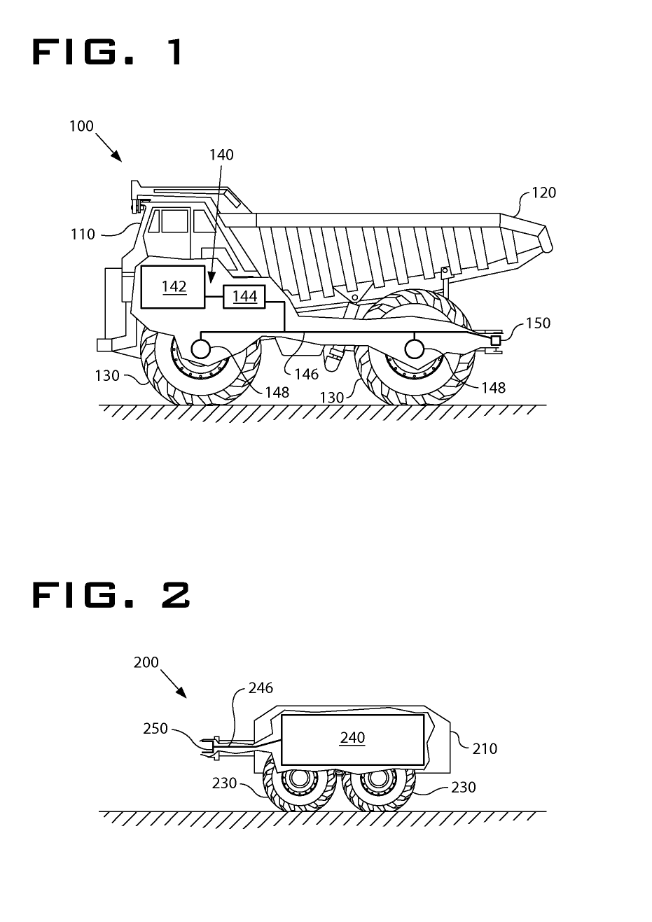

FIG. 2 illustrates an exemplary embodiment of the energy storage machine 200. The embodiment of the energy storage machine 200 includes a chassis 210 rotatably connected to wheels 230. In the illustrated embodiment, the energy storage machine 200 includes wheels 230 on at least two separate axles (not shown); however, alternative embodiments include motive assembly configurations wherein only a single axle (not shown) may be used, configurations wherein more than two axles (not shown) may be used and even configurations wherein no axles (not shown) may be used, such as in a spherical wheel arrangement.

The energy storage machine 200 also includes an energy storage device, which in this particular embodiment is a battery 240. In one exemplary embodiment, the battery 240 is connected via wiring 246 to a second connection assembly 250. Cost, weight, complexity and maintainability of the energy storage machine 200 are especially important given that the energy storage machine 200 may be used in rugged and remote environments. Therefore, a simple configuration of the energy storage machine 200 may be critical to commercial success of any system implementing the same.

The second connection assembly 250 electrically connects the energy storage machine 200 and the work machine 100. In one exemplary embodiment, the second connection assembly 250, together with the first connection assembly 150, provides both an electrical connection and a mechanical connection to the work machine 100. In one exemplary embodiment, the second connection assembly 250 may include any one of a mechanical Janney-type coupler (not shown), a tow hitch (not shown), a PTO unit and yoke connection (not shown), and a pintle hook and lunette ring and a separate electrical connection (not shown). In another exemplary embodiment, the mechanism that provides the mechanical coupling also provides the electrical coupling. The second connection assembly 250 is electrically connected to the at least one electric traction motor 148 via the first connection assembly 150. In one exemplary embodiment wherein the first connection assembly 150 and the second connection assembly 250 include PTO units, the PTO unit and yoke associated with the work machine 100 may include a splined driveshaft (not shown) which operates an electrical generator (not shown) in the energy storage machine 200.

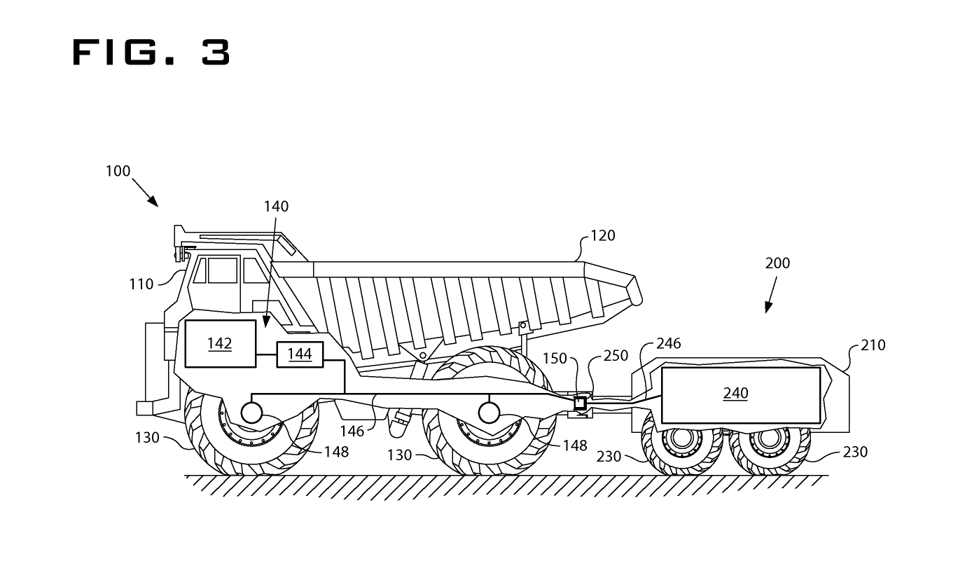

FIG. 3 illustrates an exemplary embodiment of a coupled work machine 100 and energy storage machine 200. As shown in FIG. 3, the first and second connection assemblies 150 and 250 provide a mechanical linkage between the two machines and also provides an electrical connection between the battery 240 and the at least one electric traction motor 148 on the work machine. In this configuration, the battery 240 may store energy generated by the at least one traction motor 148, e.g., energy generated by the at least one electric traction motor 148 via regenerative braking In addition, in this configuration, the battery 240 may deliver stored energy to the at least one electric traction motor 148 in addition to, or as an alternative to, the energy generated by the generator 144, e.g., in a hill-climbing application as will be discussed in more detail below.

### INDUSTRIAL APPLICABILITY

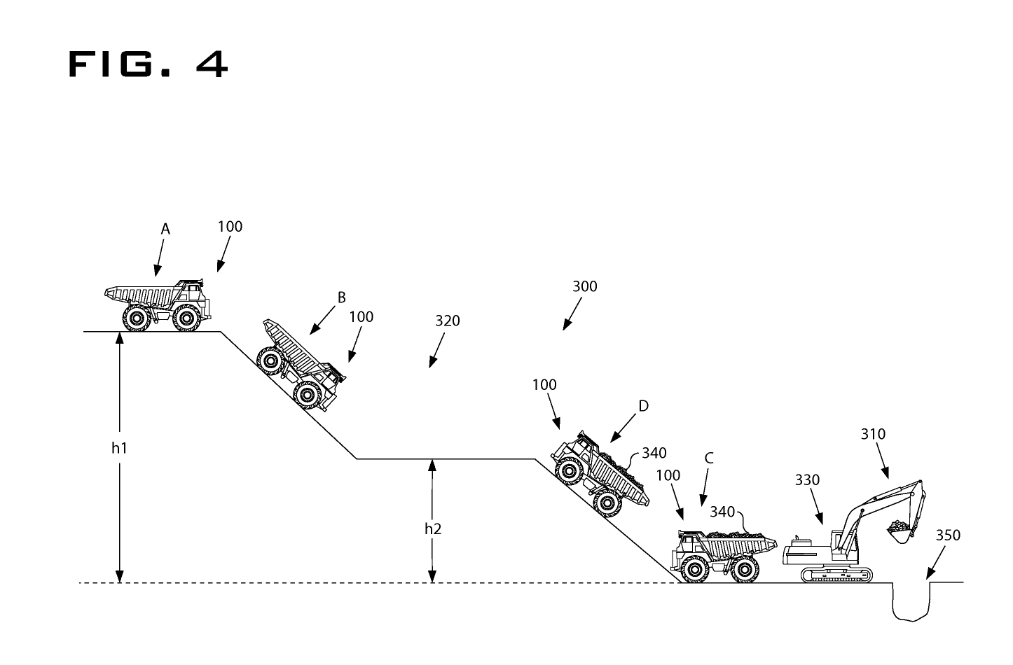

A method of utilizing the energy storage machine 200 to store potential energy and a method of utilizing the energy storage machine 200 to expend stored energy are disclosed below with respect to FIGS. 4-14. As described in more detail with respect to FIGS. 4-14, the method, and system of components used in the method, converts potential energy into kinetic energy and then into energy stored onboard the energy storage machine 200 which may be used later. In one embodiment, the method/system converts mechanical energy to electrical energy, which may then later be converted back into mechanical energy. This is in contrast to the prior art, which teaches the conversion of potential energy into kinetic energy and then into thermal energy, such as in mechanical braking applications where brake pads and disks rub together to slow a machine, or in a machine that uses regenerative braking to generate electricity that is then expended to thermal energy via a resistor array or other apparatus. The present disclosure provides a means for utilizing the energy that the prior art radiates to the environment as unused heat.

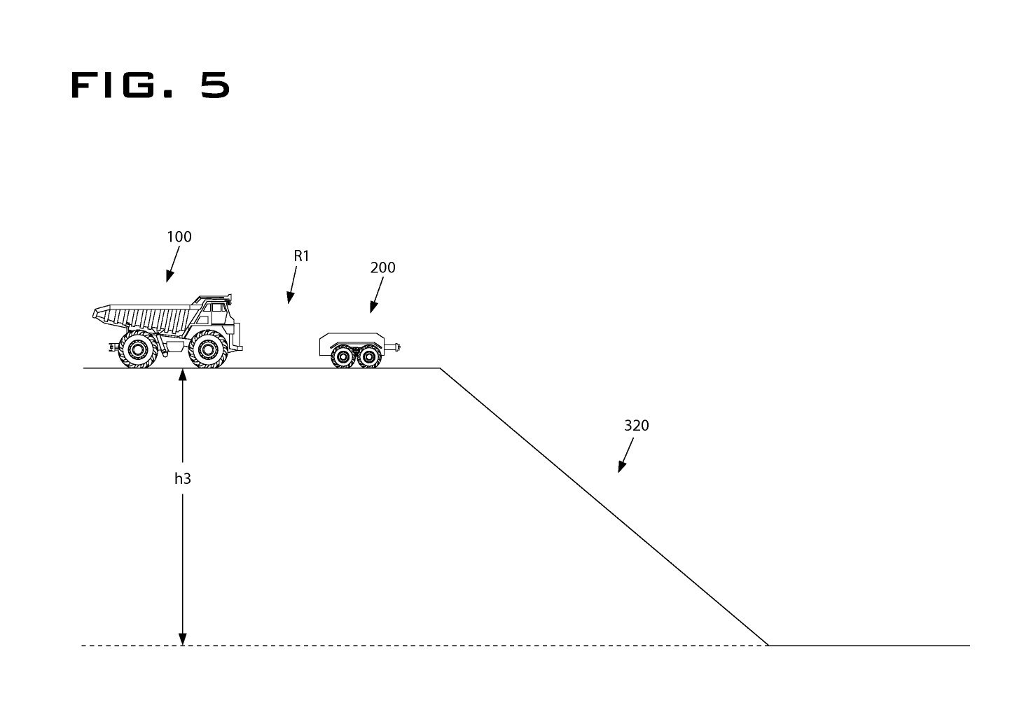

FIG. 4 is a schematic diagram of an exemplary embodiment of a worksite 300. In the present embodiment, the worksite 300 includes a working area, e.g., an excavation zone 310, and a pathway 320 leading to the excavation zone 310 from an outside, e.g., an unloading zone (not shown). The excavation zone 310 may include an excavator 330 for depositing a load 340 of material excavated from a working face 350 into the working machine 100. The pathway 320 descends from the outside to the excavation zone 310 over a vertical distance h1. The pathway 320 may include various inclined and level surfaces as illustrated in FIG. 4, or may include a single inclined surface (as described in more detail with respect to FIG. 5).

In operation, a work machine 100 begins a descent to the excavation zone 310 at point A. The work machine 100 descends along the pathway 320 at points B and D to arrive at the excavation zone 310. Along the descent, the machine converts the potential energy it had at point A to kinetic energy. The kinetic energy must be maintained within a predetermined range in order for the work machine 100 to maintain safe operation. The potential energy of the work machine 100 is a function of the position of the work machine 100 within the Earth's gravitational field as described in equation 1:

Potential Energy=m*g*h <Equation 1>

wherein “m” is the mass of the work machine 100, “g” is the acceleration due to gravity, and “h” is the altitude of the work machine 100 within the gravitation field. Thus, as h decreases, the potential energy of the work machine 100 also decreases. That is, if a height h2 were half a height h1, the potential energy as measured at h2 would be half the potential energy at height h1. Similarly, at the excavation zone 310, all of the potential energy in the system has been converted to other forms of energy through the conservation of energy.

The decrease in potential energy is converted to kinetic energy as described in equation 2:

Kinetic Energy=0.5*m*v̂2 <Equation 2>

wherein “v” is the velocity of the work machine 100. Thus, if left unchecked, the change in potential energy would rapidly lead to a large increase in velocity of the work machine 100 along the pathway 320. However, the work machine 100 includes a system for maintaining the velocity of the work machine 100, i.e., a braking system, as will be discussed in greater detail below.

The work machine 100 receives the load 340 at point C in the excavation zone 310. The load 340 must then be taken away from the excavation zone 310 to the outside, e.g., to the unloading zone (not shown). The work machine 100 provides a motive force to commute up the pathway 320 through points D and B. Essentially, the work machine 100 converts chemical energy stored in its fuel, e.g., diesel fuel, into kinetic energy via the propulsion system 140. Once the work machine 100 arrives at point A, it again has a large potential energy relative to the starting position at the excavation zone 310. The present disclosure provides a method and system for utilizing potential energy converted during the descent to the excavation zone 310 and to decrease the amount of chemical energy required to return the work machine 100 to the unloading zone. The system and method will be described in more detail below with respect to FIGS. 5-14.

FIG. 5 is a schematic diagram of a first step in an exemplary embodiment of a method of utilizing the energy storage machine 200 to store energy. As illustrated in FIG. 5, the work machine 100 arrives at a first rendezvous point R1 where the energy storage machine 200 is waiting for coupling. Both the work machine 100 and the energy storage machine 200 are disposed at a height “h3” above the excavation zone 310. The pathway 320 has been simplified in this example for illustrative purposes only. At this stage in the method, the work machine 100 and the energy storage machine 200 are not mechanically or electrically coupled.

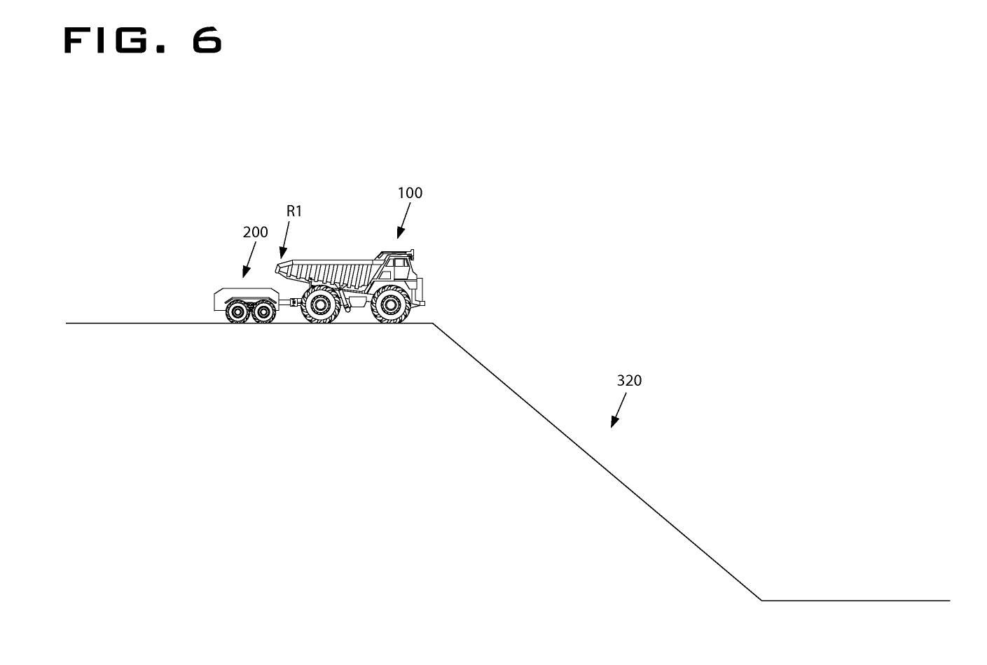

FIG. 6 is a schematic diagram of a second step in an exemplary embodiment of a method of utilizing the energy storage machine 200 to store energy. As illustrated in FIG. 6, the work machine 100 and the energy storage machine 200 are coupled, both mechanically and electrically at the first rendezvous point R1. Embodiments include configurations where a driver of the work machine 100 or other personnel performs the coupling. Embodiments also include configurations wherein the work machine 100 or the energy storage machine 200 include mechanisms for automatically performing the coupling process without user interaction. Such automated systems may utilize radar, global positioning system (“GPS”) information, radio frequency identification (“RFID”) or various other locating and navigating schema for performing the coupling. Embodiments include configurations wherein the work machine 100 and the energy storage machine 200 are in motion at the time of coupling.

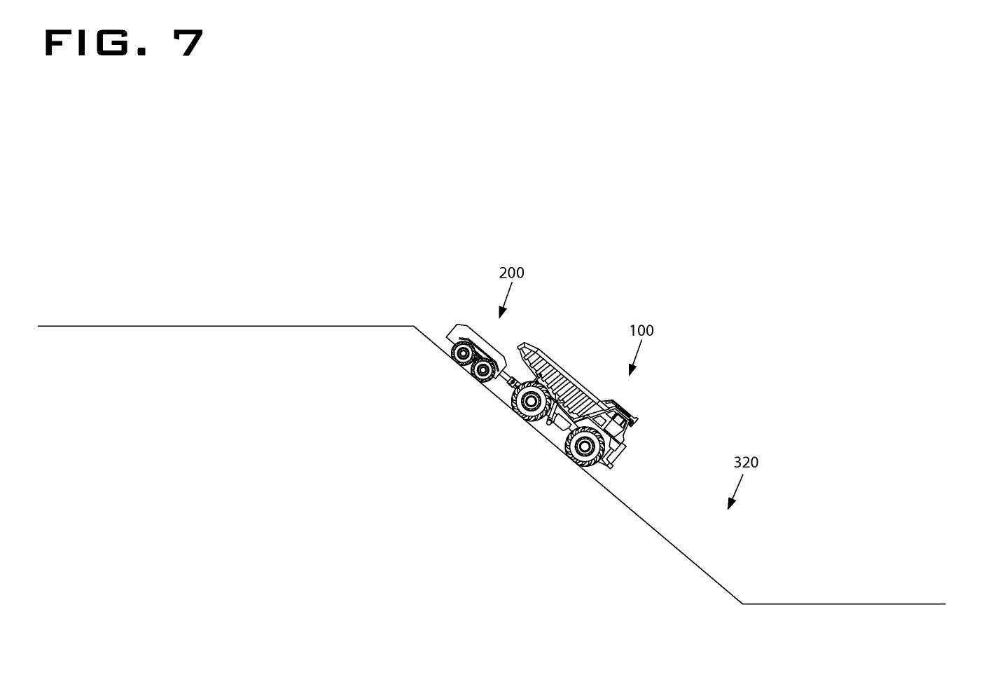

FIG. 7 is a schematic diagram of a third step in an exemplary embodiment of a method of utilizing the energy storage machine 200 to store energy. As the work machine 100 and energy storage machine 200 commute down the inclined portion of the pathway 320, a braking force is applied in order to prevent unwanted acceleration. That is, as potential energy is converted to kinetic energy, the braking force is applied to prevent velocity from increasing beyond a predetermined rate. In the present exemplary embodiment, the braking force may be at least partially applied via regenerative braking utilizing the at least one traction motor 148 in the work machine 100.

As used herein, regenerative braking applies to a control scheme where the at least one traction motor 148 of the work machine 100 is operated to generate electricity from a rotation of the wheels 130. Essentially, the regenerative braking functions substantially oppositely to the operation of providing motive force to the wheels 130; rather than converting electricity to provide a motive force, a motive force is converted to electricity.

The electricity generated by the above method is stored in the energy storage machine 200. The electricity may be transferred from the work machine 100 to the energy storage machine 200 via the connection assemblies 150 and 250.

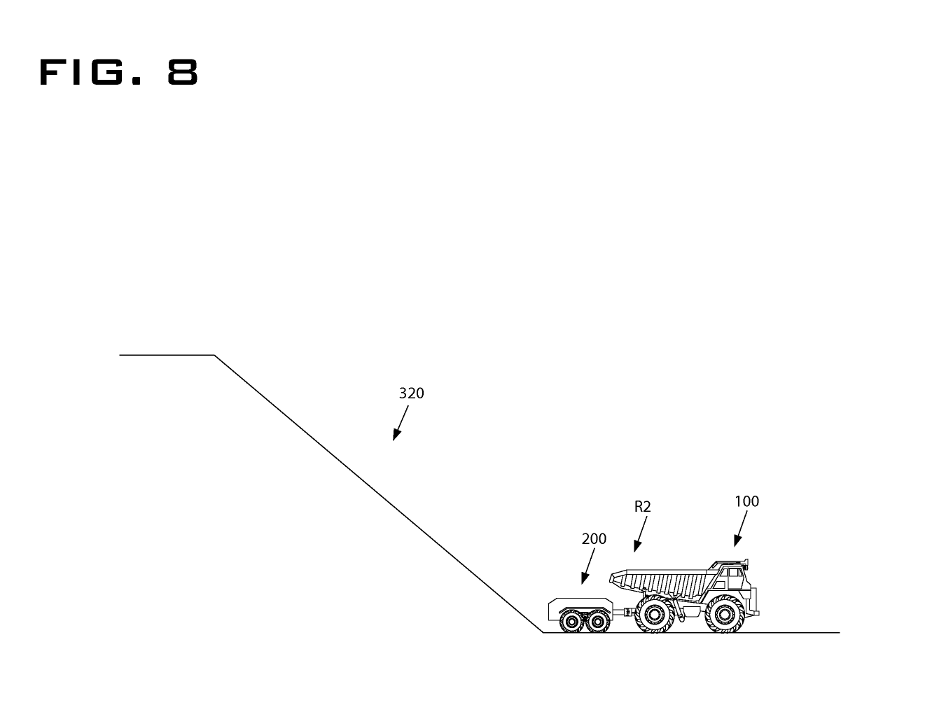

FIG. 8 is a schematic diagram of a fourth step in an exemplary embodiment of a method of utilizing the energy storage machine 200 to store energy. As illustrated in FIG. 8, the work machine 100 and energy storage machine 200 reach a second rendezvous point R2 that is substantially at a same height as the excavation zone 310. In this embodiment, the height of the second rendezvous point R2 is substantially less than the first rendezvous point R1 by a distance equal to h3, and at least a fraction of the differences in potential energy of the work machine 100 and the energy storage machine 200 combination at the first rendezvous point R1 and the second rendezvous point R2 has been converted to electrical energy. At this point the work machine 100 and the energy storage machine 200 are still mechanically and electrically coupled. The battery 240 of the energy storage machine 200 has been at least partially charged by the regenerative braking process described above.

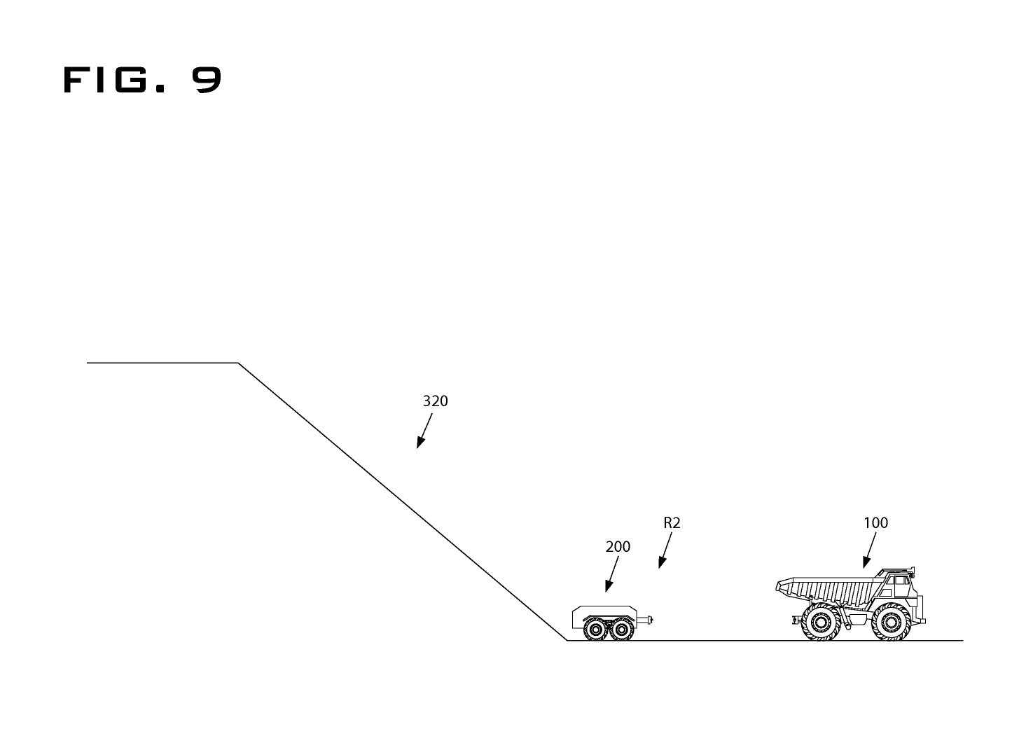

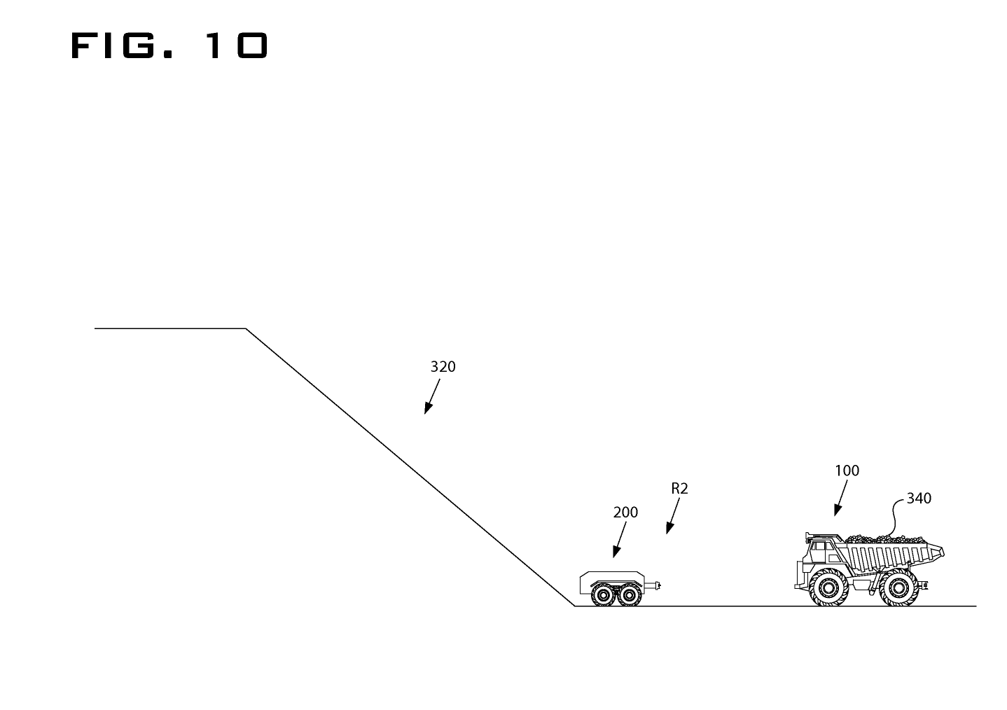

FIG. 9 is a schematic diagram of a fifth step in an exemplary embodiment of a method of utilizing the energy storage machine 200 to store energy. As illustrated in FIG. 9, the work machine 100 continues to commute to the excavation zone 310 while the energy storage machine 200 remains at the second rendezvous point R2. Embodiments include configurations wherein the work machine 100 and the energy storage machine 200 are in motion at the time of decoupling.

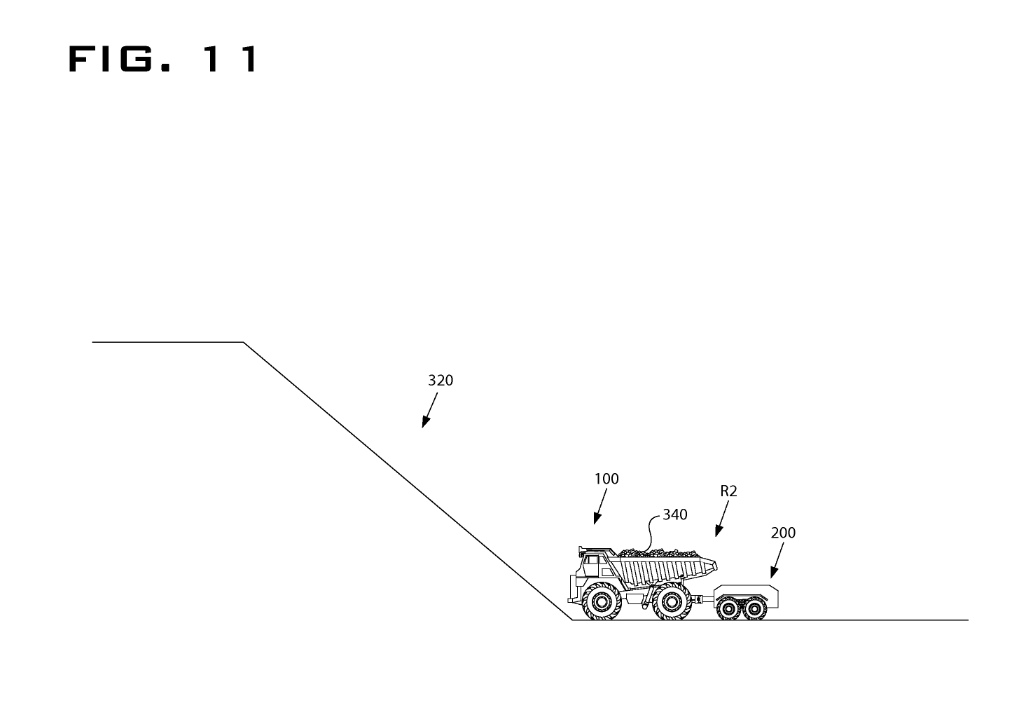

FIG. 10 is a schematic diagram of a first step in an exemplary embodiment of a method of utilizing the energy storage machine 200 to expend energy. As illustrated in FIG. 10, the work machine 100 arrives at the second rendezvous point R2 with a load 340. At this point, the work machine 100 and the energy storage machine 200 are not mechanically or electrically coupled. However, the battery 240 of the energy storage machine 200 is at least partially charged by the trip down the pathway 320. In the embodiment wherein the energy storage machine 200 includes solar panels disposed thereon, the battery 240 may also have been charged via photonic energy. Alternatively, or in addition to the solar panels, the energy storage machine 200 may be connected to an electrical grid for charging or discharging at either rendezvous point R1 or R2.

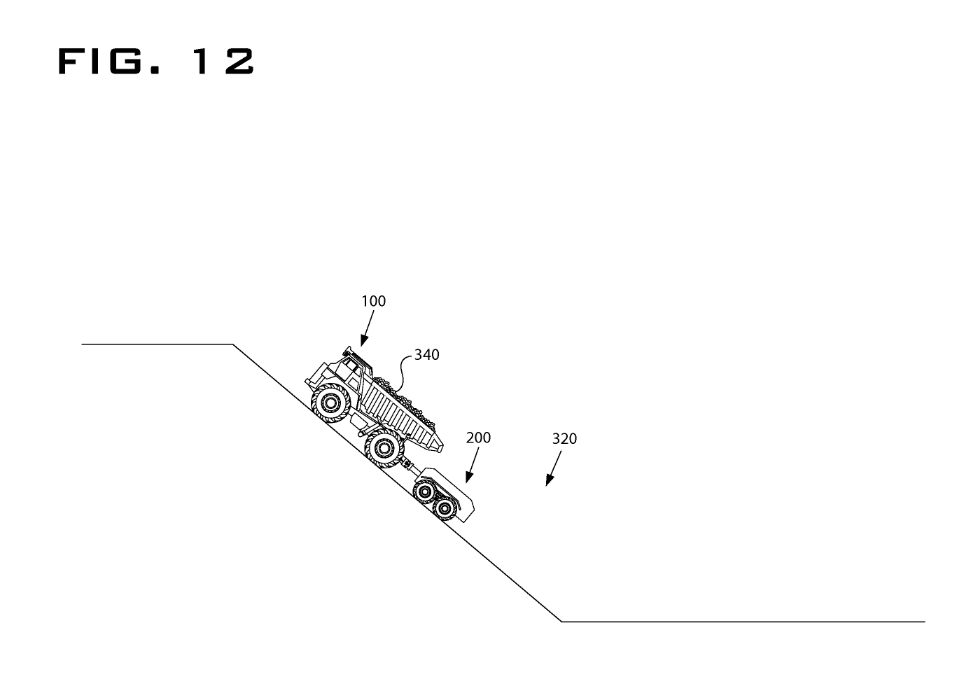

FIG. 11 is a schematic diagram of a second step in an exemplary embodiment of a method of utilizing the energy storage machine 200 to expend energy. As illustrated in FIG. 11, the work machine 100 and the energy storage machine 200 are coupled, both mechanically and electrically at the second rendezvous point R2. Embodiments include configurations where the driver of the work machine 100 or other personnel performs the coupling. Embodiments also include configurations wherein the work machine 100 or the energy storage machine 200 include mechanisms for automatically performing the coupling process without user interaction. Such automated systems may utilize radar, GPS information, RFID or various other locating and navigating schema for performing the coupling. Embodiments include configurations wherein the work machine 100 and the energy storage machine 200 are in motion at the time of coupling.

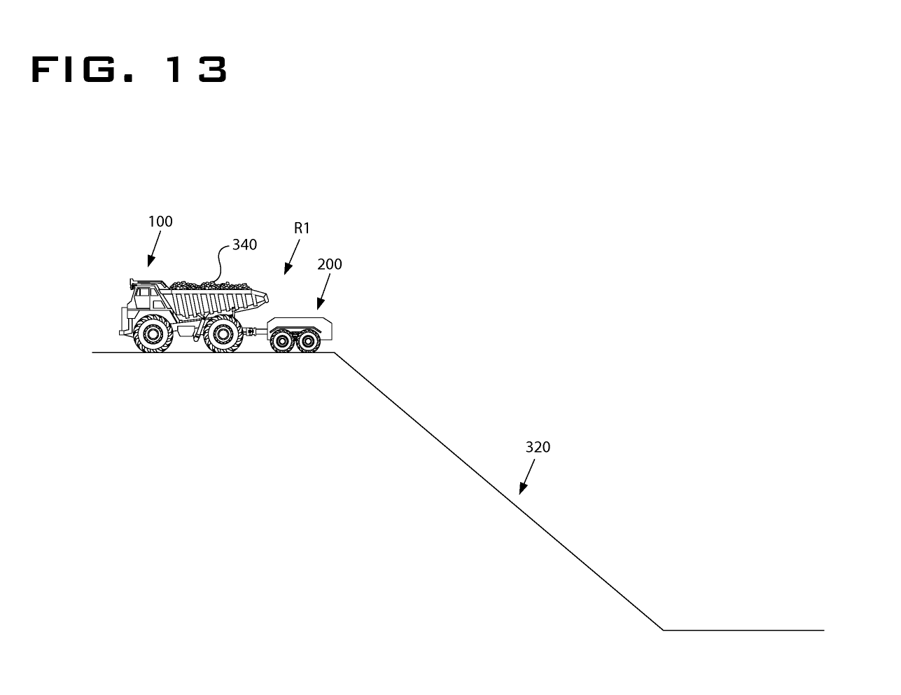

FIG. 12 is a schematic diagram of a third step in an exemplary embodiment of a method of utilizing the energy storage machine 200 to expend energy. As illustrated in FIG. 12, the work machine 100 and the energy storage machine 200 commute up the inclined portion of the pathway 320. At this stage in the method, the work machine 100 draws electricity from the battery 240 of the energy storage machine 200 in order to power the at least one traction motor 148 to provide motive force to the wheels 130.

The ability of the work machine 100 to draw power from the battery 240 provides an advantage over a system in which the energy storage machine 200 is omitted. The work machine 100 may receive at least a portion of the power required to climb the inclined portion of the pathway 320 from the battery 240, and therefore the size of the ICE 142 may be decreased by a corresponding degree. That is, rather than the ICE 142 being selected to be of a predetermined size to provide all of the energy generation capabilities required for climbing the inclined portion of the pathway 320, it may be selected to be of a size to provide only a fraction of the energy generation capabilities required for climbing the inclined portion of the pathway 320. Alternatively, the same size ICE 142 may be utilized, but run under less strenuous operating conditions and therefore the service lifetime of the ICE 142 may be extended as compared to a system that does not include the energy storage machine 200.

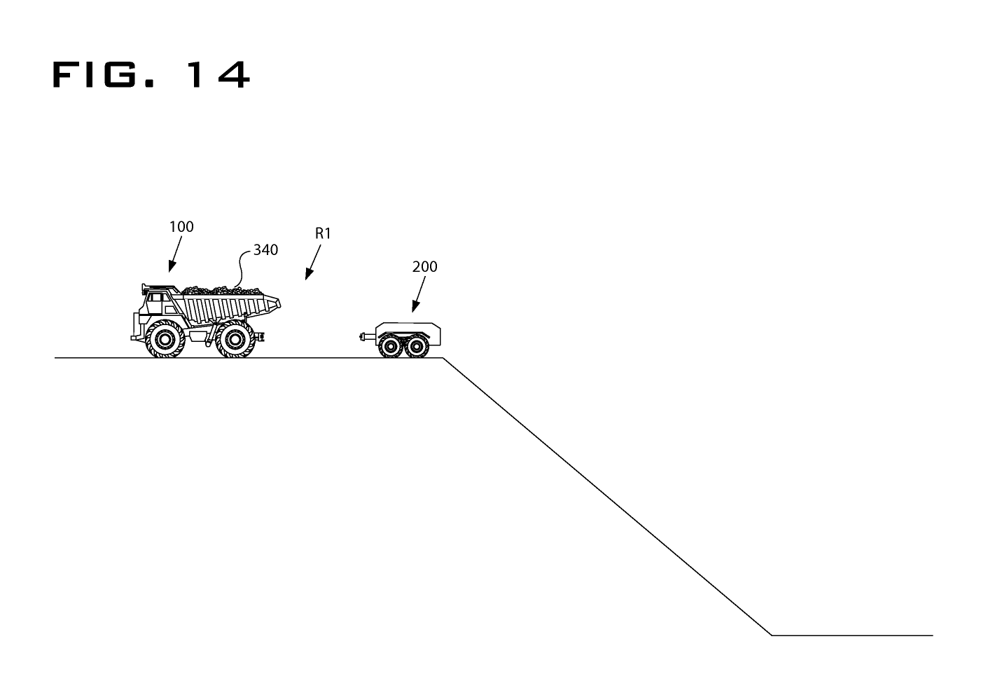

FIG. 13 is a schematic diagram of a fourth step in an exemplary embodiment of a method of utilizing the energy storage machine 200 to expend energy. As illustrated in FIG. 13, the work machine 100 and energy storage machine 200 reach the first rendezvous point R1. At this point the work machine 100 and the energy storage machine 200 are mechanically and electrically coupled. The battery 240 is at least partially depleted due to the energy usage via the work machine 100 during the ascent of the inclined portion of the pathway 320.

FIG. 14 is a schematic diagram of a fifth step in an exemplary embodiment of a method of utilizing the energy storage machine 200 to expend energy. As illustrated in FIG. 14, the work machine 100 continues to commute to the unloading zone (not shown) while the energy storage machine 200 remains at the first rendezvous point R1. Embodiments include configurations wherein the work machine 100 and the energy storage machine 200 are in motion at the time of decoupling.

While the previous illustrations have shown the energy storage machine 200 as being disposed behind the work machine 100 while in transit, the disclosure is not limited to such an embodiment. Alternative embodiments include configurations wherein the energy storage machine 200 is disposed beside or in front of the work machine 100. In addition, while the previous illustrations have shown the energy storage machine 200 as being coupled to a single work machine 100, the disclosure is not limited to such an embodiment. Alternative embodiments include configurations wherein multiple work machines 100 are coupled to a single energy storage machine 200 and configurations wherein multiple energy storage machines 200 are coupled to a single work machine 100.

While the use of at least one electric fraction motor 148 and a battery 240 have been described above as potential energy conversion and storage devices, the use of such components is only one possible configuration and alternative energy conversion and storage devices could alternatively be used, e.g., ultra-capacitors, a compressor (not shown) and compressed air storage tank (not shown), a fly-wheel drive (not shown) and flywheel (not shown), etc.

As described in detail above, the disclosed method and system provide advantages over known configurations. First, the energy storage machine 200 may reduce the operational requirements of the work machine 100 while traveling up the inclined portion of the pathway 320 by providing electric power thereto. Second, the use of the energy storage machine 200 may reduce the weight of the work machine 100 as compared to a configuration wherein a work machine carries its own batteries. That is, as compared to such a configuration, the work machine 100 of the present disclosure is lighter, both at the excavation zone 310 and at the unloading zone (not shown) by at least the weight of the batteries. Finally, because the energy storage machines 200 may be left behind at the rendezvous points R1 and R2 while the work machine 100 continues on to its next task, the energy storage machines 200 may be utilized by multiple additional work machines (not shown) while the original work machine 100 completes its task at the excavation zone 310 or unloading zone (not shown). Therefore, because multiple work machines may use a single energy storage machine 200, the total number of required batteries may be reduced as compared to the configuration in which each work machine carries its own batteries.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A method of utilizing potential energy at a worksite, the method comprising:
providing an energy storage machine including an energy storage system at a first rendezvous point at a first height above a working area;
coupling the energy storage machine to a first work machine;
generating energy while commuting the energy storage machine and first work machine down the first height;
storing the generated energy in the energy storage system; and
decoupling the energy storage machine and the first work machine at a second rendezvous point adjacent to the working area.

2. The method of claim 1, wherein the generating energy while commuting the energy storage machine and first work machine down the first height and storing the generated energy in the energy storage system includes providing an electrical regenerative braking system in the first work machine.

3. The method of claim 2, wherein the providing an electrical regenerative braking system includes providing at least one electrical traction motor that functions as a generator in the first work machine.

4. The method of claim 3, wherein the providing an energy storage machine including an energy storage system includes:
providing a battery in the energy storage machine; and
transmitting electrical energy to the battery from the at least one electrical traction motor in the first work machine.

5. The method of claim 1, further including:
coupling the energy storage machine to a second work machine at the second rendezvous point;
expending energy from the energy storage system while commuting the energy storage machine and the second working machine up a second height; and
decoupling the energy storage machine and the second work machine at the first rendezvous point at the second height above the working area,
wherein the second working machine is the same as, or different than, the first working machine, and
wherein the second height is the same as, or different than, the first height.

6. The method of claim 8, wherein the expending energy from the energy storage system while commuting the energy storage machine and the second working machine up a second height comprises:
providing a battery in the energy storage machine; and
providing at least one electrical traction motor in the second work machine in connection with the battery.

7. The method of claim 9, wherein the providing at least one electrical traction motor in the second work machine in connection with the battery includes:
providing an electrical traction motor in all wheels of the second work machine.

8. The method of claim 1 wherein the coupling the energy storage machine to the first work machine comprises utilizing at least one of a Janney-type coupler, a tow hitch and a pintle hook and lunette ring.

9. The method of claim 1, further including:
providing a solar array in electrical communication with the energy storage system of the energy storage machine.

10. An energy conversion, storage and utilization system comprising:
a worksite including a first rendezvous point and a second rendezvous point disposed at a first height below the first rendezvous point;
at least one energy storage machine that includes:
a regenerative braking system that generates energy while commuting the energy storage machine from the first area to the second area down the first height; and
an energy storage system that stores the generated energy; and
at least one work machine which is coupled to at least one of the at least one energy storage machines while the energy is generated,
wherein the at least one energy storage machine and the at least one work machine are coupled at the first rendezvous point and decoupled at the second rendezvous point.

11. The energy conversion, storage and utilization system of claim 15, wherein the at least one work machine receives energy from the at least one energy storage machine while the at least one work machine commutes from the second rendezvous point to the first rendezvous point.

12. The energy conversion, storage and utilization system of claim 10,
wherein the at least one energy storage machine includes a plurality of energy storage machines,
wherein the at least one work machine includes a plurality of work machines, and
wherein multiple energy storage machines are coupled to an individual work machine of the plurality of work machines.

13. The energy conversion, storage and utilization system of claim 10,
wherein the at least one energy storage machine includes a plurality of energy storage machines,
wherein the at least one work machine includes a plurality of work machines, and
wherein multiple work machines are coupled to an individual energy storage machine of the plurality of energy storage machines.

14. The energy conversion, storage and utilization system of claim 10, wherein the at least one work machine is an off-highway truck.

15. The energy conversion, storage and utilization system of claim 10, wherein the at least one energy storage machine and the at least one work machine are configured for use in an underground mine.

16. An energy storage machine comprising:
a chassis;
a motive assembly connected to the chassis;
an energy storage system; and
a coupler configured for connection with a work machine, wherein the coupler mechanically couples the energy storage machine to the work machine and the coupler provides an energy transfer path between the work machine and the energy storage system.

17. The energy storage machine of claim 16, wherein the motive assembly includes a two axle configuration.

18. The energy storage machine of claim 16, wherein the energy storage system includes at least one of a battery, an ultracapacitor, a compressed air reservoir and a flywheel.

19. The energy storage machine of claim 16, wherein the energy storage system is configured to be pulled behind the work machine.

20. The energy storage machine of claim 16, wherein the energy storage system is configured to be pushed in front of the work machine.
